(19) United States
(12) Patent Application Publication
(10) Pub. No.: US 2008/0046440 A1
(43) Pub. Date: Feb. 21, 2008

(54) Method And System For Enforcing User-Defined Relational Limitations In A Recursive Relational Database Table

(76) Inventor: Philip F. Estes, Palmyra, VA (US)

Correspondence Address: DILLON & YUDELL LLP, 8911 N. CAPITAL OF TEXAS HWY.,, SUITE 2110, AUSTIN, TX, 78759, US

(21) Appl. No.: 11/464,873

(22) Filed: Aug. 16, 2006

(51) Int. Cl. G06F 7/00

(52) U.S. Cl. 707/100

(57) ABSTRACT

A method for utilizing an enhanced relational database management system to enforce user-defined relational limitations in a relational database table containing tree-like data that includes marking a database table as containing a tree structure relationship suitable for recursive queries, inserting a parent-child relationship schema into the tree-based database table, receiving a request from a user to insert or update a database record within the database table, verifying that the object types of the database record being inserted/updated satisfy the parent-child relationship schema of the database table, and inserting/updating the database record only if the object types of the database record satisfy the parent-child relationship schema of the database table.

### BACKGROUND OF THE INVENTION

1. Technical Field

The present invention relates in general to the field of computers and other data processing systems and in particular to database management. Still more particularly, the present invention relates to an improved method and system for enforcing relational limitations in a relational database table containing tree-like data.

2. Description of the Related Art

A database contains a plurality of records systematically stored within a computer, such that a computer program may access the records in response to queries. A computer program known as a database management system (DBMS) is used to manage and query a database. Within a database, records are organized according to a schema, which describes the structure of a database. Schemas conventionally include a set of data items, typically in the form of tables having a plurality of data columns. Relational databases are structured in accordance with a relational model, which is a data model based on predicate logic and set theory.

To enhance the user friendliness of relational databases in the real world, relational database management systems may include additional features, such as indices, that help make data items more easily accessible. Computer languages, such as Structured Query Language (SQL), are utilized to create, modify, retrieve, and manipulate data within relational database management systems. Several database vendors (e.g. IBM's DB2) include a feature implemented via SQL whereby a user may execute “recursive queries” on tables in a database that have specifically been set up with linking columns to form a tree structure.

Conventional relational databases utilize tree structures to store large amounts of interrelated data items, such as a list of parts in a physical system. For example, given a device or product containing thousands of parts, a data table can be structured to contain unique keys for each part of the device, such that the data table contains the entire parts list in a tree format. In such a case, the data table uses parent or child ID columns to relate that part A is the parent of parts B, C, D, and that part D is in turn a parent of parts E, F, G, etc. After the execution of an SQL command that trimmed or pared the tree in such a way as to retrieve a set of results requested by the database user, a recursive query could be used to regenerate a view of the entire tree or any sub-tree.

In some cases, a user may need to represent a complex schema as a tree structure. Enforcing the rules of a complex schema at the application level could potentially be error prone and/or time consuming. Although a relational database user could write code to control the insertion of data into a data table represented as a complex tree structure, conventional methods do not exist to allow a database management system to enforce a given schema on a tree structure. The present invention thus recognizes that an improved method and system for enforcing user-defined relational limitations on the schema of a relational database table is needed.

### SUMMARY OF THE INVENTION

Disclosed is a method, system, and computer program product for enforcing user-defined relational limitations in a relational database table containing tree-like data. In one embodiment, the method includes, but is not limited to, the steps of: marking a database table as containing a tree structure relationship suitable for recursive query; inserting a parent-child relationship schema into the tree-based database table; receiving a request from a user to insert or update a database record within the database table; utilizing an enhanced relational database management system to verify that the object types of the database record being inserted/updated satisfy the parent-child relationship schema of the database table; and inserting/updating the database record only if the object types of the database record satisfy the parent-child relationship schema of the database table.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary data processing system, as utilized in an embodiment of the present invention;

FIG. 2 illustrates a high level block diagram of a relational database management system (RDBMS), as used in an embodiment of the present invention;

FIG. 3 is a high level logical flowchart of an exemplary method of inserting relationship constraints into a database table in accordance with one embodiment of the invention; and

FIG. 4 is a high level logical flowchart of an exemplary method of controlling the insertion of a database record into a database table in accordance with one embodiment of the invention.

### DETAILED DESCRIPTION OF AN ILLUSTRATIVE EMBODIMENT

The present invention provides a method, system, and computer program product for enforcing user-defined relational limitations in a relational database table containing tree-like data.

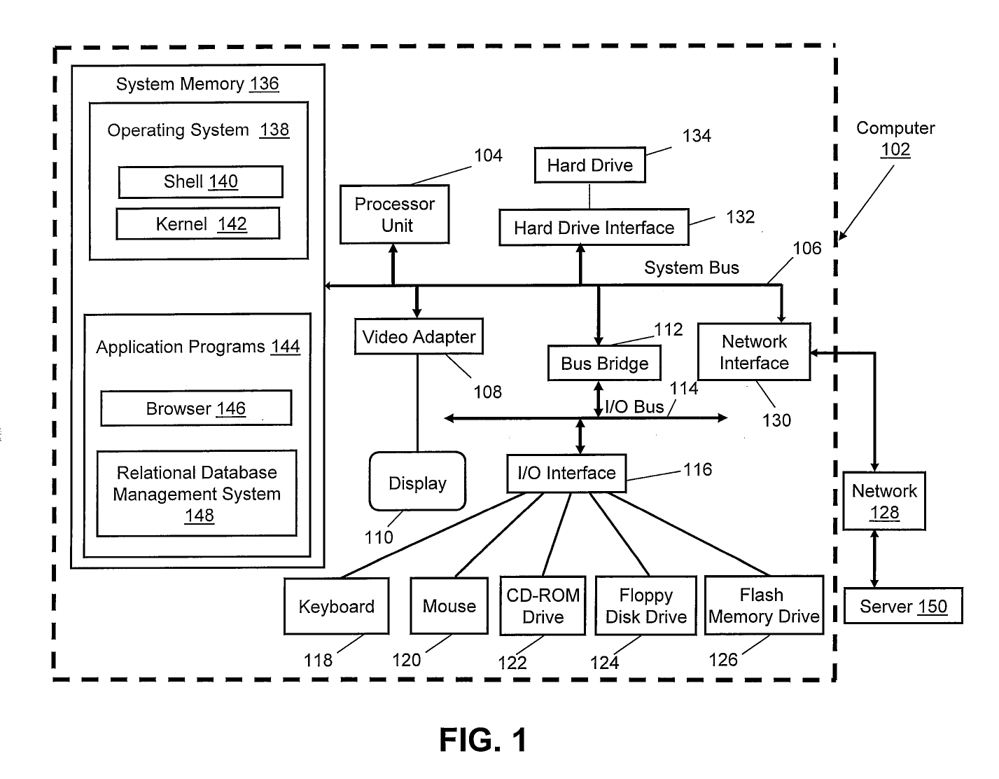

With reference now to FIG. 1, there is depicted a block diagram of an exemplary computer 102, with which the present invention may be utilized. Computer 102 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk—Read Only Memory (CD-ROM) drive 122, floppy disk drive 124, and flash drive memory 126. The format of the ports connected to I/O interface 116 may be any format known to those skilled in the art of computer architecture, including but not limited to Universal Serial Bus (USB) ports.

Computer 102 is able to communicate with server 150 via network 128 using network interface 130, which is coupled to system bus 106. Network 128 may be an external network such as the Internet, or an internal network such as an Ethernet or a Virtual Private Network (VPN). Using network 128, computer 102 is able to use the present invention to access server 150.

Hard drive interface 132 is also coupled to system bus 106. Hard drive interface 132 interfaces with hard drive 134. In a preferred embodiment, hard drive 134 populates system memory 136, which is also coupled to system bus 106. System memory is defined as a lowest level of volatile memory in computer 102. This volatile memory may include additional higher levels of volatile memory (not shown), including, but not limited to, cache memory, registers and buffers. Data that populates system memory 136 includes operating system (OS) 138 and application programs 144.

OS 138 includes shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with server 150. While browser 146 may communicate with server 150 via HTTP messaging, conventional database programs typically utilize “wire protocols” to communicate with other computers, such as server 150, via network 128.

Application programs 144 in system memory 136 also include relational database management system (RDBMS) 148. Although illustrated as a single component, in some embodiments RDBMS 148 may be formed of multiple software components.

The hardware elements depicted in computer 102 are not intended to be exhaustive, but rather are representative to highlight certain components that mat be utilized to practice the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

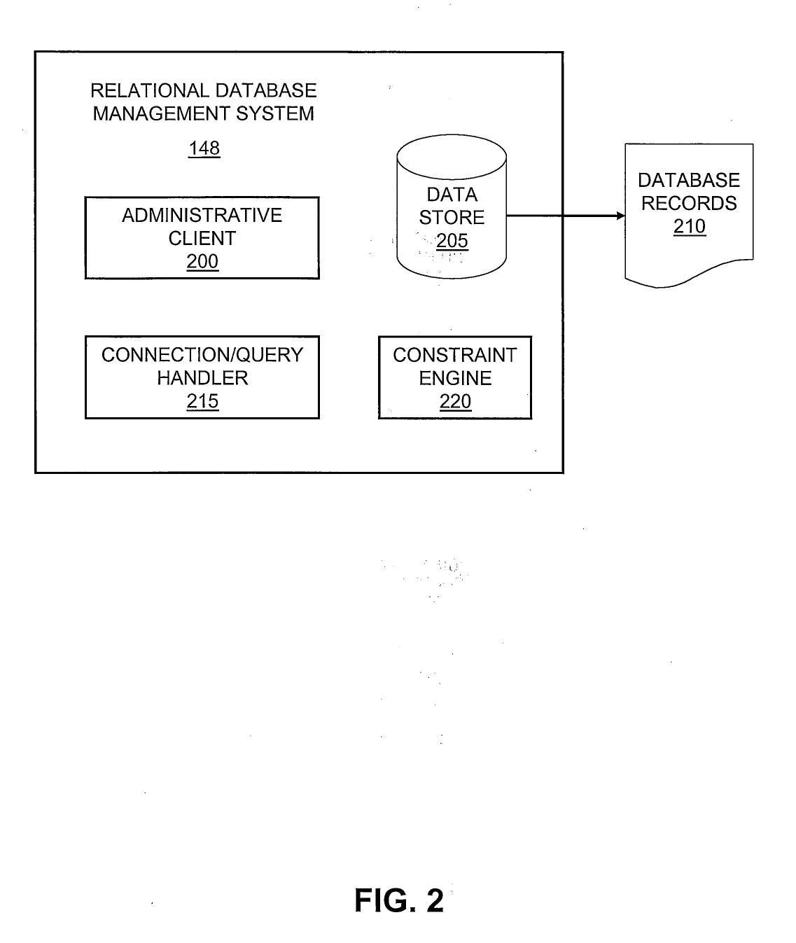

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

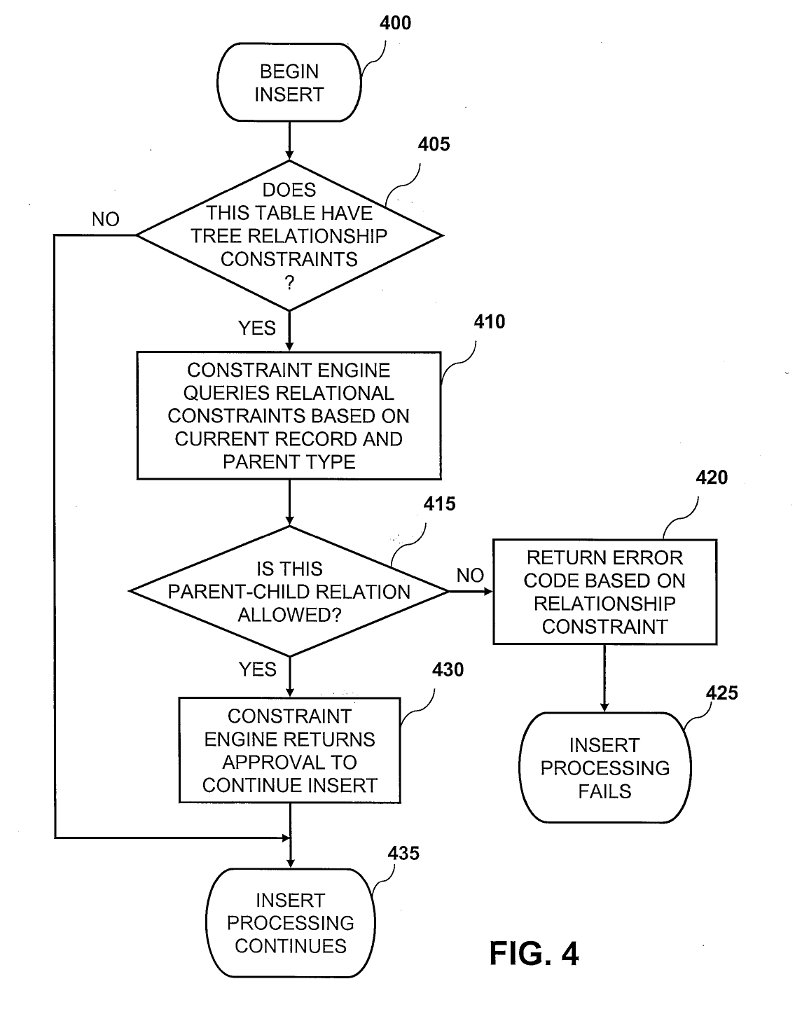

With reference now to FIG. 2, there is depicted a high level block diagram of a RDBMS 148, as utilized in an embodiment of the present invention. RDBMS 148 includes administrative client 200, data store 205, connection/query handler 215, and constraint engine 220. Data store 205 comprises a plurality of database records 210, each of which may be a database table representing a data tree structure. Administrative client 200 controls the processes implemented by RDBMS 148 in response to commands received from a user of computer 102. Connection/query handler 215 acts as a user interface and may provide the user with a database control panel, thereby enabling the user to control the operation of administrative client 200, data store 205, and constraint engine 220. In one embodiment, constraint engine 220 controls the process of inserting new nodes into the data tree structure, as depicted in FIG. 4, which is discussed in detail below.

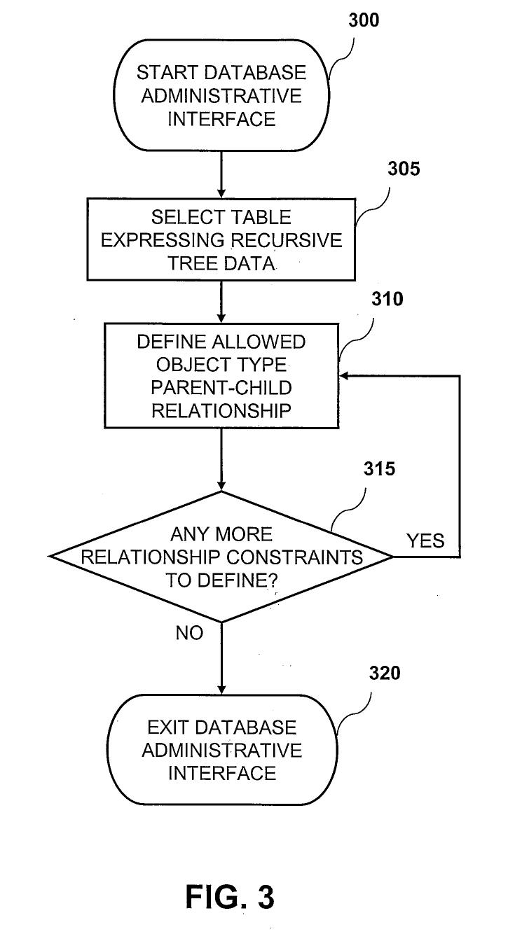

Within a database table consisting of tree-structured data, a node in the tree is typically represented by a record in a corresponding database table. In one embodiment of the present invention, a database table that is organized to represent a tree structure includes a column to specify the object type of each row, a column to specify a unique identifier for each row, and a column to specify an identifier for the parent of each row. In such an embodiment, a tree structure can be extracted from a database table via a recursive table query, wherein the RDBMS will implement a query within its engine to walk the tree, follow the link for the parent identifier of that record, and then continue to following the parent identification links until the leaf or terminal nodes of the tree are reached. Each level of the tree structure typically includes nodes of a single object type. Some tree structures may also be governed by very strict requirements on parent-child node relationships. For example, the parents and/or children of the nodes at a given level of the tree structure may be restricted to nodes that have certain object types. The insertion of relationship constraints into a database table is depicted in FIG. 3 and described in detail below.

With reference now to FIG. 3, there is illustrated a high level logical flowchart of an exemplary method of inserting relationship constraints into a database table in accordance with one embodiment of the invention. The process begins at block 300, for example, in response to a user of computer 102, who preferably performs the illustrated steps of FIG. 3 in order to identify to RDBMS 148 which database tables need further automated processing, as illustrated in FIG. 4 and described in detail below. At block 305, a user of computer 102 selects database record 210 as containing tree-like data. In an alternative embodiment, at block 305, administrative client 200 may also add metadata information into database record 210 selected by the user in order to facilitate the identification of record 210 by RDBMS 148 as having tree-like data.

At block 310, a user of computer 102 utilizes features provided by administrative client 200 to define an allowed object type parent-child relationship for a record within the database table. In response to data entered by the user, administrative client 200 updates the metadata of the selected database table, such that the user-defined parent-child relationship is stored within the database table.

A decision is made at block 315 whether additional parent-child relationship constraints have yet to be defined by the user in order to represent the database table as a tree structure. If the user still needs to define additional parent-child relationships, administrative client 200 returns to block 310 and a user of computer 102 utilizes features provided by administrative client 200 to define an allowed object type parent-child relationship for another record within the database table. If the user has finished defining parent-child relationships for the database table, such that the database table can be accurately represented as a tree structure, the user prompts administrative client 200 to terminate the relationship constraint insertion process at block 320.

Turning now to FIG. 4, there is illustrated a high level logical flowchart of an exemplary method of controlling the insertion of a database record into a database table in accordance with one embodiment of the invention. The process begins at block 400, for example, in response to a user of computer 102 invoking RDBMS 148, by executing a Structured Query Language (SQL) insert/update command. At block 405 a determination is made whether the database table contains metadata signifying that the database table is organized as a tree structure and has relationship constraints (e.g. a parent identification column) governing the parent-child relationships of the database records. If the database table does not contain metadata to signify that the database table is organized as a tree structure and/or does not contain relationship constraints, then RDBMS 148 executes the SQL insert/update command and continues with a conventional database record insertion process at block 435.

If the database table is organized as a tree structure and does have relationship constraints, then constraint engine 220 queries the relationship constraints based on the object type of the database record being evaluated for insertion and the object type of the proposed parent of the database record being evaluated for insertion, as depicted at block 410. A determination is then made at block 415 whether the parent-child relationship between the database record being evaluated for insertion and the potential parent is allowed by the relationship constraints of the database table. If the proposed parent-child relationship is not allowed based on the relationship constraints of the database table, an SQL error code(s) based on the violated relationship constraint(s) is returned to the user via connection/query handler 215 at block 420 and connection/query handler 215 terminates the insertion process at block 425, such that the record being evaluated for insertion is not inserted into the database table.

If constraint engine 220 determines that the proposed parent-child relationship is allowed based on the relationship constraints of the database table, connection/query handler 215 returns an approval message to a user of computer 102, as depicted at block 430. At block 435, RDBMS 148 executes the SQL insert/update command previously entered by the user and continues with a conventional database record insertion process, such that the record being evaluated for insertion is thereby inserted into the database table.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A method of enforcing user-defined relational limitations in a recursive relational database table, the method comprising:
marking a database table as containing a tree structure relationship that is suitable for recursive query operations;
inserting a parent-child relationship schema into the database table;
receiving a request from a user of the database table to insert a database record within the database table;
utilizing an enhanced database management system to verify that object types of a database record being inserted satisfies the parent-child relationship schema in the database table; and
inserting the database record only if the object types of the database record satisfy the parent-child relationship schema of the database table.

2. The method of claim 1, wherein the database table containing the tree structure relationship suitable for recursive query operations comprises a column to specify an object type of each database record in the database table, a column to specify a unique identifier for each database record in the database table, and a column to specify an identifier for a parent of each database record in the database table.

3. The method of claim 1, wherein the database table containing the tree structure relationship suitable for recursive query operations comprises a unique identifier to specify an object type of each database record in the database table, a unique identifier to specify each database record in the database table, and a unique identifier to specify a parent of each database record in the database table.

4. The method of claim 1, wherein the parent-child relationship schema comprises an expression of allowed record-to-record object types for any parent to child linked records in the database table.

5. A computer-readable medium embodying computer program code for controlling access to a relational database, the computer program code comprising computer executable instructions configured for:
marking a database table as containing a tree structure relationship that is suitable for recursive query operations;
inserting a parent-child relationship schema into the database table;
receiving a request from a user of the database table to insert a database record within the database table;
utilizing an enhanced database management system to verify that object types of a database record being inserted satisfies the parent-child relationship schema in the database table; and
inserting the database record only if the object types of the database record satisfy the parent-child relationship schema of the database table.

6. The computer-readable medium of claim 5, wherein the database table containing the tree structure relationship suitable for recursive query operations comprises a column to specify an object type of each database record in the database table, a column to specify a unique identifier for each database record in the database table, and a column to specify an identifier for a parent of each database record in the database table.

7. The computer-readable medium of claim 5, wherein the database table containing the tree structure relationship suitable for recursive query operations comprises a unique identifier to specify an object type of each database record in the database table, a unique identifier to specify each database record in the database table, and a unique identifier to specify a parent of each database record in the database table.

8. The computer-readable medium of claim 5, wherein the parent-child relationship schema comprises an expression of allowed record-to-record object types for any parent to child linked records in the database table.

9. A system comprising:
a processor;
a data bus coupled to the processor;
a memory coupled to the data bus; and
a computer-usable medium embodying computer program code, the computer program code comprising instructions executable by the processor and configured for:
marking a database table as containing a tree structure relationship that is suitable for recursive query operations;
inserting a parent-child relationship schema into the database table;
receiving a request from a user of the database table to insert a database record within the database table;
utilizing an enhanced database management system to verify that object types of a database record being inserted satisfies the parent-child relationship schema in the database table; and
inserting the database record only if the object types of the database record satisfy the parent-child relationship schema of the database table.

10. The system of claim 9, wherein the database table containing the tree structure relationship suitable for recursive query operations comprises a column to specify an object type of each database record in the database table, a column to specify a unique identifier for each database record in the database table, and a column to specify an identifier for a parent of each database record in the database table.

11. The system of claim 9, wherein the database table containing the tree structure relationship suitable for recursive query operations comprises a unique identifier to specify an object type of each database record in the database table, a unique identifier to specify each database record in the database table, and a unique identifier to specify a parent of each database record in the database table.

12. The system of claim 9, wherein the parent-child relationship schema comprises an expression of allowed record-to-record object types for any parent to child linked records in the database table.
